(19) United States
(12) Patent Application Publication
(10) Pub. No.: US 2006/0057951 A1
(43) Pub. Date: Mar. 16, 2006

(54) Noise prevention structure of a vehicle air duct

(75) Inventor: In-Kwon Jung, Yongin-si (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Seoul (KR)

(21) Appl. No.: 11/195,815

(22) Filed: Aug. 3, 2005

(30) Foreign Application Priority Data
Sep. 15, 2004 (KR) 2004-73955

(51) Int. Cl. B60H 1/00; B60H 1/26

(52) U.S. Cl. 454/143; 454/906

(57) ABSTRACT

A noise prevention structure for a vehicle air duct includes a duct body installed in a discharge port and guiding purified air into the vehicle, a door rotatably installed in the duct body, and opening and closing the duct body by a user; and a lip installed around a rim of the door and closely contacting with the inner wall of the duct body when the door is closed. The lip has a curved-shape so as to prevent noise from being generated due to the air stream passing between the inner wall of the duct body and the lip when the door is ajar.

### RELATED APPLICATIONS

The present disclosure relates to subject matter contained in Korean Application No.10-2004-73955, filed on Sep. 15, 2004, which is herein expressly incorporated by reference its entirety.

### BACKGROUND OF THE INVENTION

1. Field of the Invention

The present invention relates to a structure for preventing air ducts of vehicles from generating noise, and more particularly, to a noise prevention structure for a vehicle air duct which reduces the whistle noise generated when a vent door is ajar by forming a rubber lip in a curved shape to be installed to the rim of a flow rate adjusting knob.

2. Description of the Related Art

Generally, air conditioners are mounted in vehicles so as to improve comfort by maintaining air temperature in the vehicle, and every air conditioner includes an inlet port for introducing air into the vehicle or the exterior, a discharge port for discharging the introduced air into the vehicle, and an air duct.

FIG. 1 is an exploded perspective view illustrating a conventional air duct of a vehicle.

The conventional air duct, includes a duct body 10 installed at the inside of the discharge port and guiding the purified air into the vehicle, a blade 30 rotatably installed inside the duct body 10 and adjusting the direction of the discharged air stream, and a door 20 for opening and closing the duct body 10 by a user so as to adjust the amount of discharged air.

Here, the blade 30 includes a vertical blade 32 having a plurality of vertically installed blades to rotate right and left so as to determine the right and left directions of the discharged air stream, a horizontal blade 34 having a plurality of horizontally installed blades to rotate up and down so as to determine the upward and downward directions of the discharged air stream, and a flow rate adjusting knob 36 connected to the vertical blade 32 and the horizontal blade 34, protruding out of the duct body 10, and selectively rotating the vertical blade 32 or the horizontal blade 34 by the user.

In addition, the duct body 10 includes a flow rate adjusting knob 12, which protrudes out of the instrument panel and is connected to the door 20 by means of plural links 14, so that, when a driver or a passenger operates the flow rate adjusting knob 12, the force is transmitted to rotate the door 20, and thus the duct body 10 is opened.

The door 20 includes an elastic lip 22 at the rim thereof, and since the lip 22 is made of an elastic material such as rubber, the lip 22 can completely close the duct body 10 so as to prevent the air discharged from the duct body 10 from being leaked when the door 20 is closed.

However, in the conventional air duct, since the door 20 is made of a quadrangular plate corresponding to the cross-section of the duct body 10, links 14 connected to the flow rate adjusting knob 12 and hinges are installed at the side central portions thereof, and the lip 22 is welded to or inserted into the rim, in a state where the door 20 is almost closed, the air passes through a gap between the duct body 10 and the lip 22 and vibrates the lip 22, and thus noise occurs.

This noise is known as “whistle noise”. Since the whistle noise is generated when the aquatic energy of a specific frequency band is concentrated as shown in FIG. 2, causes annoyance to passengers, and is generated in most vehicles having such a door 20, the passenger compartment of the vehicle must be not silent.

### SUMMARY OF THE INVENTION

Therefore, the present invention has been made in view of the above and/or other problems, and it is an object of the present invention to provide a noise prevention structure of a vehicle air duct in which a curve-shaped lip is installed to a door rim so as to form a streamlined passage for the air stream passing through a narrow space between the lip and a duct body when the duct body is ajar, and thus to minimize friction between the duct body and the lip, resulting in a reduction of the whistle noise.

In accordance with the present invention, the above and other aspects can be accomplished by the provision of a noise prevention structure a vehicle air duct including a duct body installed at the inside of a discharge port and guiding the purified air into the vehicle, a door rotatably installed in the duct body and opening and closing the duct body by a user, and lips installed at the rim of the door and coming in close contact with the inner wall of the duct body when the door is closed, wherein the lips has the curved-shape so as to prevent noise from being generated due to the air stream passing between the inner wall of the duct body and the lip when the door is ajar.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is an exploded perspective view illustrating a conventional air duct of a vehicle;

FIG. 2 is a graph showing the frequency of noise generated in the conventional air duct of a vehicle;

FIG. 3 is a perspective view illustrating a partially cut-away noise prevention structure of a vehicle air duct according to the present invention;

FIG. 4 is an enlarged partial view illustrating the noise prevention structure of a vehicle air duct according to the present invention; and

FIG. 5 is a graph showing the frequency of noise reduced by the noise prevention structure of a vehicle air duct according to the present invention.

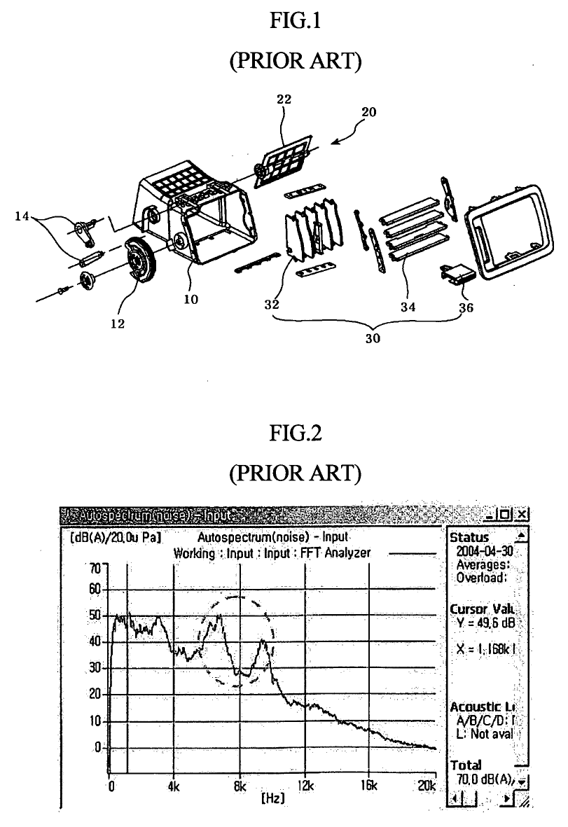

### DESCRIPTION OF THE PREFERRED EMBODIMENTS

Hereinafter, the preferred embodiment of the noise prevention structure of a vehicle air duct according to the present invention will be described in detail with reference to the accompanying drawings.

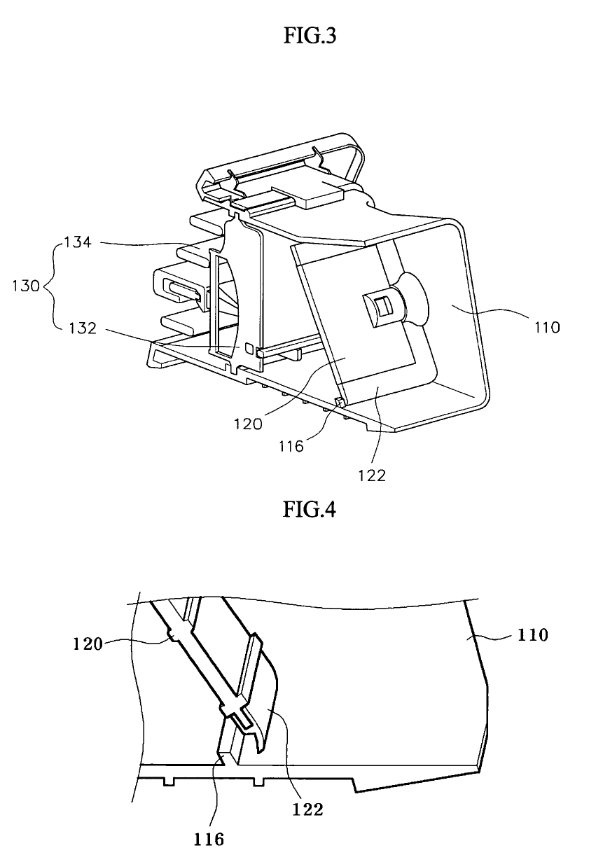

FIG. 3 is a perspective view illustrating a partially cut-away noise prevention structure of a vehicle air duct according to the present invention.

The air duct adopting the present invention includes a duct body 110 installed at the inside of a discharge port and guiding the purified air into the vehicle, a blade 130 rotatably installed inside the duct body 110 and adjusting the direction of the discharged air stream, and a door 120 for opening and closing the duct body 10 by a user so as to adjust the amount of discharged air.

Here, the blade 130 includes a vertical blade 132 having a plurality of vertically installed blades to rotate right and left so as to determine the right and left directions of the discharged air stream, a horizontal blade 134 having a plurality of horizontally installed blades to rotate up and down so as to determine the upward and downward directions of the discharged air stream, and a flow rate adjusting knob 136 connected to the vertical blade 132 and the horizontal blade 134, protruding out of the duct body 110, and selectively rotating the vertical blade 132 or the horizontal blade 134 by the user.

The door 120 is connected to the flow rate adjusting knob 136 installed to the side of the duct body 110 by means of a plurality of links. Since the flow rate adjusting knob protrudes out of the instrument panel so that a user can operate, the driver or passenger moves the flow rate adjusting knob so that the force is transmitted to the door through the links and the door is rotated to open or close the duct body 110.

In addition, the door 120 is inclined at a predetermined angle such that the upper end thereof is located downstream of the discharge port, is transversely installed with a rotation shaft at the central portion thereof so that the door 120 can be rotated. The duct body 110 is formed with steps 116 rear of the upper end of the door 120 and in front of the lower end of the door 120, respectively, so that a lip 122 described later comes in close contact with the steps 116 when the door 120 is closed.

Moreover, the door 120 is installed with an elastic lip 122 at the rim thereof. Since the lip 122 is made of an elastic material such as rubber, the lip 122 comes into close contact with the inner wall of the duct body 110 so as to prevent the discharged air from being leaked when the door 120 is closed.

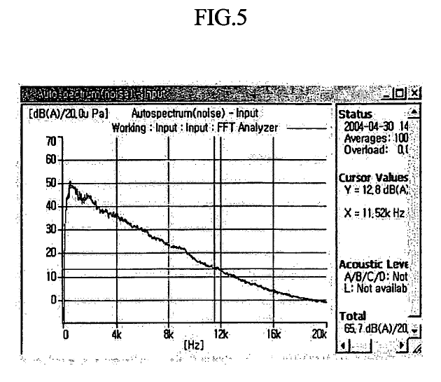

FIG. 4 is an enlarged partial view illustrating the door and the lip of the noise prevention structure of a vehicle air duct according to the present invention.

The lip 122, as shown in FIG. 4, is formed in a curved-shape, and the curve-shaped lip 122 is installed only at the lower end of the door 120 disposed in the duct body 110, while the surface thereof with which the air stream discharged from the duct body 110 comes in contact with, is convex, so that it is possible to prevent the air passage from becoming narrower due to the curved-shape of the lip 122 when the air is discharged under the condition that the door 120 is ajar.

Here, since the lip 122 is rotated downward, that is, in the counter-clockwise by the discharged air, the lip 122 installed at the upper end of the door 120 is moved away from the step 116 so as to secure the air passage. Therefore, though the lip of the upper end of the door 120 is formed in the curved-shape, noise is not generated in the duct body 110.

FIG. 5 is a graph showing the frequency of noise reduced by the noise prevention structure of a vehicle air duct according to the present invention, and it is to be understood, as shown in the drawing, that noise is not generated at a specific frequency where the whistle noise depicted as a dotted line is generated in the conventional air duct shown in FIG. 2.

As described above, in the noise prevention structure of a vehicle air duct according to the present invention, the curve-shaped lip is installed in the region where the conventional lip is transformed by the air stream discharged from the duct body, and the transformed conventional lip makes the air passage narrower, so that the space between the curve-shaped lip and the inner wall of the air duct is guaranteed so as to prevent whistle noise from being generated due to the vibration of the conventional lip. Thus, the passenger seat of a vehicle can be kept quiet.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A noise prevention structure for a vehicle air duct comprising:
a duct body installed in a discharge port and guiding purified air into the vehicle;
a door rotatably installed in the duct body, and opening and closing the duct body by a user; and
a lip installed around a rim of the door and closely contacting the inner wall of the duct body when the door is closed;
wherein the lip has a curved-shape so as to prevent noise from being generated due to the air stream passing between the inner wall of the duct body and the lip when the door is ajar.

2. The noise prevention structure of a vehicle as set forth in claim 1, wherein the door is inclined at a predetermined angle such that either the lower end or the upper end thereof is located near a discharge port of the duct body, a rotation shaft is transversely installed at a central portion of the door so as to rotatably install the door to the inner walls of the duct body, and
the duct body is provided with at least two steps thereon, one of which is formed near a rear of the upper end of the door and the other of which is formed in front of the lower end of the door so that the lip closely contacts with each of the steps when the door is closed.

3. The noise prevention structure of a vehicle air duct as set forth in claim 1, wherein the lip is formed in a curved shape and installed only at one end of the door located near the discharge port.

4. The noise preventing structure of a vehicle air duct as set forth in claim 1, wherein the lip has a convex surface with which the air stream discharged from the duct body contacts.

5. The noise preventing structure of a vehicle air duct as set forth in claim 3, wherein the lip has a convex surface with which the air stream discharged from the duct body contacts.
